(19) United States
(12) Patent Application Publication
(10) Pub. No.: US 2023/0144239 A1
(43) Pub. Date: May 11, 2023

(54) MODULAR VIRTUAL REALITY ENVIRONMENT

(71) Applicant: Wells Fargo Bank, N.A., San Francisco, CA (US)

(72) Inventors: Chris Theodore Kalaboukis, San Jose, CA (US); Rameshchandra Bhaskar Ketharaju, Hyderabad (IN); Joon Maeng, Newcastle, WA (US); Pankaj Parekh, San Francisco, CA (US); Abhijit Rao, Irvine, CA (US); Abhijit Shetti, Pleasanton, CA (US); Dennis E. Montenegro, Concord, CA (US); Chandramouli Subramanian, San Ramon, CA (US); Ramanathan Ramanathan, Bellevue, WA (US)

(21) Appl. No.: 16/949,024

(22) Filed: Oct. 9, 2020

Related U.S. Application Data
(60) Provisional application No. 62/913,525, filed on Oct. 10, 2019.

(51) Int. Cl. G06Q 20/10; G06Q 20/32; G06Q 20/40; G06T 19/00

(52) U.S. Cl. CPC G06Q 20/1085; G06Q 20/321; G06Q 20/327; G06Q 20/3223; G06Q 20/40145; G06T 19/006

(57) ABSTRACT

A method may include receiving, by a sensor in a modular banking environment an identification a computing device associated with a user, the environment including a set of physical components associated with banking functionality; detecting a user physically entering the environment based on the receiving; receiving an input associated with a transaction request from the user via a virtual reality device in the modular banking environment; transmitting a command to the set of physical components based on the transaction request; configuring the set of physical components according to the command to facilitate the transaction; determining, based on the transaction request that a second user is needed to complete the transaction request; transmitting a connection request to a computing device of the second user to connect the second user with the first user; and based on the connection request being accepted, displaying a representation of the second user within the environment.

### CROSS-REFERENCE TO RELATED APPLICATION

This patent application claims the benefit of U.S. Provisional Pat. Application No. 62/913,525, filed Oct. 10, 2019, which is incorporated by reference herein in its entirety.

### BACKGROUND

It is not always possible for a person to physically go to an established banking environment, whether an automated teller machine or retail store, for a variety of reasons. For example, many people do not have transportation options, they work during normal retail hours, or are sick. Furthermore, conditions outside of an individual may prevent the bank from being open such as pandemics or natural disasters. Additionally, despite the increase in functionality of mobile devices to perform banking functions, limitations still exist. For example, a mobile device may not be able to print a credit card and may only provide limited interactions with other users via video calls.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is an illustration of a modular banking environment, according to various examples.

FIG. 2 is an illustration of components of a modular banking control device, according to various examples.

FIG. 3 is an illustration of a flowchart, according to various examples.

FIG. 4 is a block diagram illustrating a machine in the example form of computer system, within which a set or sequence of instructions may be executed to cause the machine to perform any one of the methodologies discussed herein, according to various examples.

### DETAILED DESCRIPTION

In the following description, for purposes of explanation, numerous specific details are set forth to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., RAM, cache, hard drive) accessible by the component via an API or other program communication method. Similarly, the variables may be assumed to have a default values should a specific value not be described. User interfaces may be provided for an end-user or administrator to edit the variable values in some instances.

As indicated in the background, there are a variety of reasons why a user may be unable to go to a traditional banking environment. In some instances, a user may try and accomplish their transaction using a mobile phone but find the functionality of their mobile device is insufficient. For example, consider that the user needs a new bank card printed because their existing one was stolen, they need to sign physical closing documents, or they need to withdraw funds.

In other instances, virtual reality systems have been used to try and recreate the banking environment. But these systems suffer from many of the same problems as using a mobile banking app. Although they may recreate a more immersive experience, they still do not have the components necessary to perform several banking system functions.

What is needed is an improvement to virtual reality systems and remote banking devices that promote interoperability between banking components and virtual reality components. In such a manner, the functionality of virtual systems and banking systems is improved. For example, in the described virtual banking environment there is the ability to have virtual participants such that the virtual participants have banking-focused components (e.g., bill dispensers) co-located with the virtual participants. The banking system also gets the benefit of having another input device (e.g., a remote virtual reality device). Furthermore, the virtual reality systems are enhanced because--as described in more detail below--these systems may now control banking components to assist the user in completing a transaction instead of just providing an enhanced communication environment.

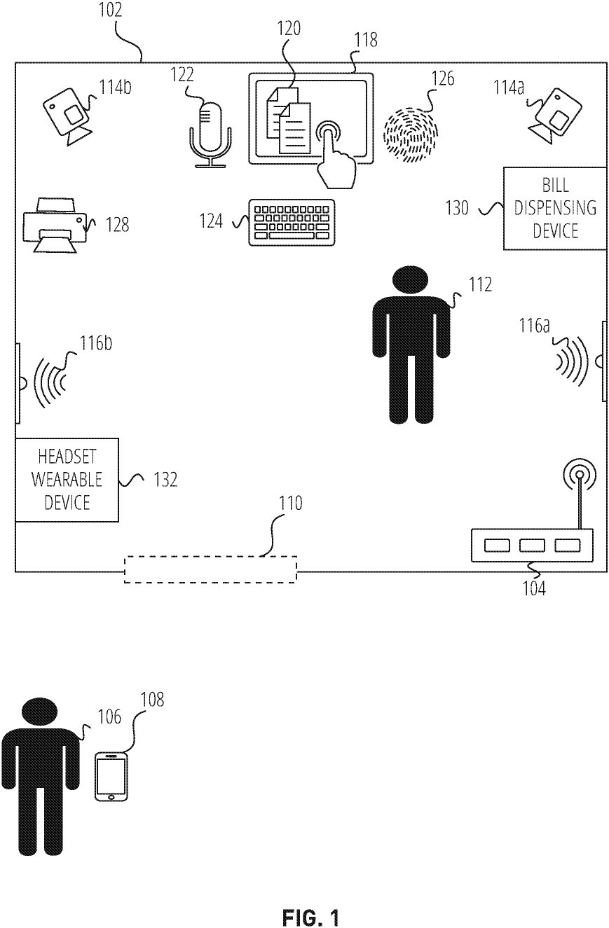

FIG. 1 is an illustration of a modular banking environment 102, according to various examples. The figure comprises modular banking environment 102, a modular banking control device 104, a user 106, a user computing device 108, an entrance 110, a virtual user 112, a camera 114a, a camera 114b, a proximity sensor 116b, a proximity sensor 116a, a display device 118, a document 120, a microphone 122, a keyboard input device 124, a biometric authentication device 126, a printer device 128, a bill dispensing device 130, and a headset wearable device 132.

Modular banking environment 102 may be deployed in several configurations. For example, modular banking environment 102 may be set up in a room of a nursing home. In other examples, smaller deployments may be used as well such as an office with cubicles. Thus, there may be multiple modular banking environments in a single, physical location (e.g., with partitions between them, in cubicles, etc.).

In another configuration, the various components of modular banking environment 102 may be part of a mobile cart. In such a scenario, user 106 may walk up to the cart and place on headset wearable device 132. The act of putting on headset wearable device 132 may establish the presence of user 106 to modular banking control device 104; however, sensors such as proximity sensor 116a may still be used.

For discussion purposes, an ongoing example is discussed in which user 106 is a resident of a nursing home and needs to perform a transaction at a bank but is unable to travel to a financial institution. Accordingly, the nursing home may have a room that the user can enter that includes modular banking environment 102. The placement of the sensors, cameras, other devices in modular banking environment 102 are merely illustrative and other placements may be used. Additionally, because the system is modular, more or fewer sensors/cameras/components may be used without departing from the scope of this disclosure.

User computing device 108 may take many forms. For example, user computing device 108 may be the user’s personal mobile device, a tablet, a laptop, etc. User computing device 108 may include a display module to display information (e.g., in the form of specially configured user interfaces). In some embodiments, computing devices may comprise one or more of a touch screen, camera, keyboard, microphone, or Global Positioning System (GPS). User computing device 108 may be capable of short-range communication using Near Field Communication (NFC) or Bluetooth. Similarly, sensors may be able to detect the presence of user computing device 108 using the short-range communication capabilities of user computing device 108.

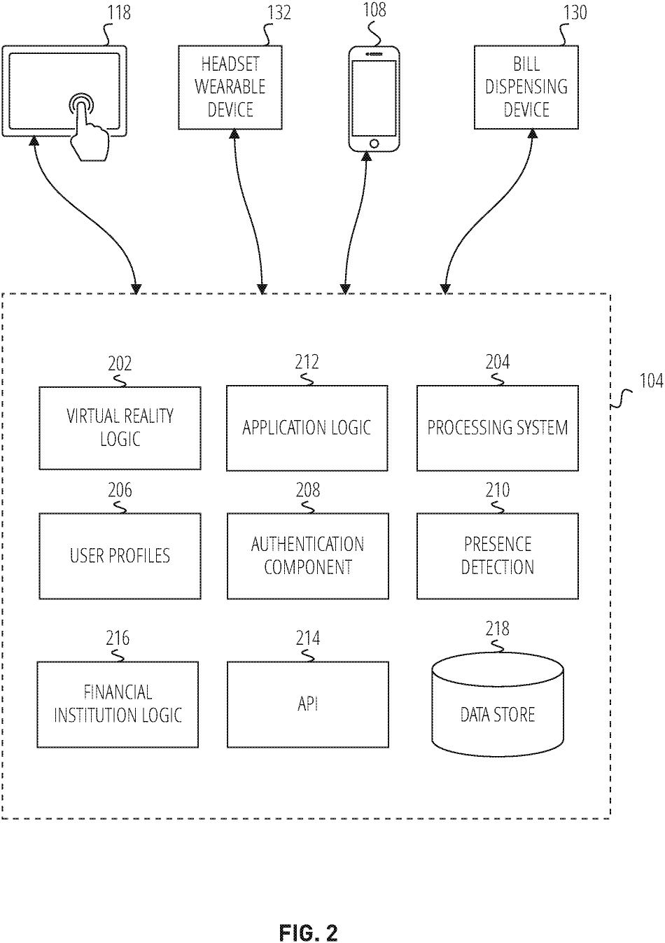

Modular banking control device 104 may be configured to communicate (wirelessly or wired) with the different components in modular banking environment 102. A brief overview of modular banking control device 104 is presented here. For a more complete description of modular banking control device 104 see the discussion of FIG. 2. Modular banking control device 104 may programmatically transmit and receive data from the components in modular banking environment 102 to present a virtual banking environment to user 106. A virtual banking environment may be an environment in which information is presented to a user at least partially through a virtual reality device (e.g., headset wearable device 132) while also including a set of physical components (which may themselves be virtual reality devices in some instances) that the user 106 may interact with to complete a transaction.

User 106 may walk into modular banking environment 102 via entrance 110. Entrance 110 may be an opening or be a door. In either case, entrance 110 may be configured to detect when a user walks in or out of modular banking environment 102. For example, entrance 110 may include a motion sensor or Bluetooth beacon that notes motion or a signal from user computing device 108, respectively. In lieu of, or in addition, to sensors in entrance 110, other sensors such as proximity sensor 116b and proximity sensor 116a may detect the presence of user 106 in a similar manner.

Once a sensor in entrance 110, proximity sensor 116a, or proximity sensor 116b senses user 106 it may transmit a notification to modular banking control device 104. For example, an NFC chip in user computing device 108 may include an identifier which is read by proximity sensor 116a. The identifier may have been previously been associated with user 106 within a user profile (e.g., user profiles 206 in FIG. 2). Thus, when user 106 is detected, modular banking control device 104 may configure the components of modular banking environment 102 based on the user’s previously stored preferences. For example, headset wearable device 132 may be configured to present certain information (e.g., a balance) about user 106’s account at a financial institution when user 106 puts on headset wearable device 132.

Modular banking environment 102 may include a variety of types of components associated with banking functionality. For example, there may be input devices such as microphone 122, keyboard input device 124, and biometric authentication device 126. In some examples, there may be pens, wands, etc., (not shown) in modular banking environment 102 that have markings on them that are tracked by camera 114b and fed to modular banking control device 104. Thus, a user may use a pen or stylus to digitally sign a document in the air, for example.

Biometric authentication device 126 may be used as an extra level of security when using modular banking environment 102. For example, if someone steals another person’s phone, they may be able to walk into modular banking environment 102 and have their presence detected. Without an additional identity check, such as by using biometric authentication device 126, the bad actor may be able to perform banking transactions.

In some examples, a user may use an application on user computing device 108 to perform the additional authentication. For example, user 106 may open a banking application user computing device 108 and authenticate themselves via the application. The authentication information may be transmitted to modular banking control device 104. Modular banking control device 104 may then determine if the original identification based on proximity sensor 116a matches the authentication from user computing device 108 before allowing any transactions to take place.

Output devices may include headset wearable device 132, display device 118, bill dispensing device 130, and printer device 128. Some of the output devices may be specialized for banking functionality such as bill dispensing device 130. Printer device 128 may be specialized for banking and be configured to print smart cards, credit cards, etc., for user 106 in response to a transaction request (as discussed in more detail below). Some devices may include both input and output functionality. For example, display device 118 may be a touchscreen and accept a signature from a user. Display device 118 may be used in instances where a user does not want to use a virtual banking environment but still wants the benefit of the functionality of the room. In some instances, display device 118 may be used to augment what is being presented in the virtual banking environment. For example, document 120 may be a mirror of what is being presented via headset wearable device 132. Keyboard input device 124 and display device 118 may be used to edit a user’s profile in some examples.

Headset wearable device 132 may be glasses or goggles that include side barriers to block out peripheral vision, in various examples. Headset wearable device 132 may include displays or projectors to display a video stream or still images on a user’s eyes. The video stream may present the virtual banking environment in virtual reality as determined in part by modular banking control device 104. In various examples, “virtual reality” means presenting an immersive experience in which outside light and audio sources are minimized, or presenting an augmented reality experience in which images or video are overlaid on what the user (or a camera) is viewing. The opacity level of overlaid images in an AR setting may be configurable by the user.

Camera 114a may include a depth sensor that maps objects in the room as well as tracks movements of user 106 and other objects in the modular banking environment. The data from camera 114a may be transmitted to modular banking control device 104. Modular banking control device 104 may use the received information when generating a full or partial three-dimensional representation of modular banking environment 102. In an immersive virtual reality environment, the representation may be presented to the user via headset wearable device 132. In an augmented virtual reality environment, the representation may be used to calculate where to project images or objects to the user via headset wearable device 132.

Bill dispensing device 130 may be configured to receive information from modular banking control device 104 about when and how money to dispense to user 106. In some examples, bill dispensing device 130 may be controlled based on the action of virtual user 112 in another modular banking environment. For example, user 106 may request a withdrawal (e.g., a transaction request) from one of their accounts. Upon processing and confirming the request, modular banking control device 104 may transmit a command to bill dispensing device 130 to release funds in accordance with the transaction request. Bill dispensing device 130 may be a standalone unit within modular banking environment 102 or may be built into the room itself (e.g., a slot in a wall that can open/shut).

In some examples, bill dispensing device 130 or another document receiving device (not shown) is also able to receive bills or other documents from user 106. For example, a user may deposit signed checks or monetary bills, etc. In some examples, the document receiving device may include a scanner to scan the deposited documents/bills. Images resulting from the scan may be transmitted to modular banking control device 104 for further processing. In various examples, a document may be scanned by user 106 holding up in the air and having one of camera 114a or camera 114b take a picture of the document. The document may be a check, in some examples, that user 106 wants to deposit.

There may be other inert objects in modular banking environment 102 that modular banking control device 104 may use when presenting the virtual banking environment. For example, there may be a table in modular banking environment 102 in which a digitally document is presented (e.g., digitally overlaid) in an augmented virtual reality environment. User 106 may then use a stylus to digitally sign the document on the table.

Virtual user 112 may either be another user that is connected to another modular banking environment 102 or a virtual assistant that may assist the user. For example, there may be scenarios in which multiple parties are required to complete a transaction (e.g., a loan with multiple signers). Each required party may use their own virtual banking environment and the respective modular banking control device 104 may communicate with each other project a virtual representation of the other party. In other examples, virtual user 112 may be a customer support representative of a financial institution.

FIG. 2 is an illustration of components of modular banking control device 104, according to various examples. Modular banking control device 104 is illustrated as communicating with display device 118, bill dispensing device 130, headset wearable device 132, and user computing device 108. Modular banking control device 104 is illustrated as including, virtual reality logic 202, processing system 204, user profiles 206, authentication component 208, presence detection 210, application logic 212, API 214, financial institution logic 216, and data store 218.

Display device 118, headset wearable device 132, user computing device 108, bill dispensing device 130 and modular banking control device 104 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks or peer-to-peer (e.g., Bluetooth®, Wi-Fi Direct), or other combinations or permutations of network protocols and network types. The network may include a single Local Area Network (LAN) or Wide-Area Network (WAN), or combinations of LAN’s or WAN’s, such as the Internet.

Different devices may communicate with modular banking control device 104 using different network connections. For example, bill dispensing device 130 and modular banking control device 104 may communicate over Wi-Fi whereas user computing device 108 and modular banking control device 104 may communicate over a Bluetooth connection. Accordingly, modular banking control device 104 may include multiple network interface devices.

Modular banking control device 104 may also include a dedicated network connection to communicate with external servers. For example, a 5G connection may be used by modular banking control device 104 to insure a high-bandwidth, low-latency connection. The use of a 5G connection may enable some or all of the processing of modular banking control device 104 to be offloaded to a remote server that is physically distance from modular banking control device 104. Accordingly, one benefit of modular banking environment 102 is that it does not rely on the network infrastructure that is available at an installation site. Consequently, a virtual banking environment may be available to a user in locations which traditionally have not been able to have such functionality. Also, by relying on a remote server for processing, the power requirements of modular banking control device 104 may be kept low.

Data between modular banking control device 104 and other devices may conform to an application programming interface (API) such as API 214. An API provides a method for computing processes to exchange data. A web-based API (e.g., API 214) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a Database (e.g., data store 218).

APIs may also be defined in frameworks provided by an operating system (OS) to access data in an application that an application may not regularly be permitted to access. For example, the OS may define an API call to obtain the current location of a mobile device the OS is installed on. In another example, an application provider may use an API call to request user 106 be authenticated using a biometric sensor on the mobile device. By segregating any underlying biometric data—e.g., by using a secure element—the risk of unauthorized transmission of the biometric data may be lowered. In another example, headset wearable device 132 may include an API to access gyroscope sensor data that is part of headset wearable device 132. Thus, modular banking control device 104 may be able to use this data to determine where user 106 is looking and update virtual banking environment accordingly. APIs may also be used to control devices such as bill dispensing device 130 to dispense bills, for example.

Modular banking control device 104 is illustrated as set of separate elements (e.g., component, logic, etc.). However, the functionality of individual elements may be performed by a single element. An element may represent computer program code that is executable by processing system 204. The program code may be stored on a storage device (e.g., data store 218) and loaded into a memory of the processing system 204 for execution. Portions of the program code may be executed in a parallel across multiple processing units (e.g., a core of a general-purpose computer processor, a graphical processing unit, an application specific integrated circuit, etc.) of processing system 204. Execution of the code may be performed on a single device or distributed across multiple devices. In some example, the program code may be executed on a cloud platform (e.g., MICROSOFT AZURE® and AMAZON EC2®) using shared computing infrastructure.

Virtual reality logic 202 may include the software that generates and maintains a 3D model of an environment that is presented to user 106. For example, virtual reality logic 202 may use a virtual reality (VR) or augmented reality (AR) framework that is responsible for determining and tracking the locations of objects in modular banking environment 102. Any AR/VR framework may be used without departing from the scope of this disclosure such as UNITY3D®, UNREAL ENGINE®, IOS ARKIT®, ARCORE®, among others. Virtual reality logic 202 may receive sensor readings from depth cameras or optical cameras in modular banking environment 102 to update the virtual banking environment.

Additionally, application logic 212 may be the logic that presents virtual banking environment in the 3D model maintained by virtual reality logic 202 to present user interfaces and objects to user 106. Thus, the relationship between application logic 212 and virtual reality logic 202 may be analogous to a web server and a web application/web site. Accordingly, application logic 212 may present user interface (UI) components that are presented to user 106 via headset wearable device 132. The UI components may appear to be floating in front of the user 106 or appear to be projected onto surfaces within modular banking environment 102. In some examples, some or all the UI components are transmitted to display device 118.

User 106 may interact (e.g., select, move, enter text into) with the UI components, and based on the interaction, application logic 212 may update one or more of the UI components or add/remove UI components. For example, upon entering modular banking environment 102, a floating menu may be presented to user 106 via headset wearable device 132. The menu may include options for different transactions user 106 may wish to complete such as, but not limited to, opening an account, closing an account, transferring money, applying for a mortgage, withdrawal of money, etc.

A finger of user 106 may be tracked using camera 114b. Then, when the finger passes a boundary plane of the menu at the location of a transaction option, the virtual banking environment may update to include UI components for the transaction. In various examples, the UI components mirror those that would be presented to user 106 if the user was using a mobile app on user computing device 108. Other input mechanisms may also be used such as voice control using microphone 122 or gesture controls, in various examples.

Application logic 212 may also maintain (e.g., as stored in data store 218) a list of the set of physical components in modular banking environment 102. Each physical component may have an associated identifier (e.g., alphanumeric), location within the room, and, if applicable, capabilities of the component and network address (e.g., MAC address, IP address, Bluetooth address). By knowing the set of physical components available (and their capabilities), application logic 212 may tailor the transactions options presented to user 106 so as to not show options to withdraw money if there is no bill dispensing device, for example.

In various examples, information presented in the UI components may be sourced from external or internal data sources. For example, some of the information may originate from data store 218. Other information may be financial information that is requested by financial institution logic 216 that interacts with an external financial institution server. Application logic 212 may issue API calls to retrieve or store data from data store 218 and transmit it for display on headset wearable device 132. Similarly, data entered by a user into (virtually or via keyboard input device 124) a UI component may be transmitted using API 214 back to the Application logic 212, which may transmit it to a financial institution to complete a transaction request, in various examples.. Application logic 212 may use other elements (e.g., user profiles 206, authentication component 208, presence detection 210, financial institution logic 216, etc.) of modular banking control device 104 to perform functionality associated with application logic 212.

Data store 218 may store data that is used by modular banking control device 104. Data store 218 is depicted as a singular element but may in actuality be multiple data stores. The specific storage layout and model used in by data store 218 may take a number of forms-indeed, a data store 218 may utilize multiple models. Data store 218 may be, but is not limited to, a relational database (e.g., SQL), non-relational database (NoSQL) a flat file database, object model, document details model, graph database, shared ledger (e.g., blockchain), or a file system hierarchy. Data store 218 may store data on one or more storage devices (e.g., a hard disk, random access memory (RAM), etc.). The storage devices may be in standalone arrays, part of one or more servers, and may be located in one or more geographic areas.

User profiles 206 may store information on each user of modular banking environment 102. In some instances, user profiles 206 may be shared across multiple modular banking environments 102. For example, if user 106 enters another modular banking environment 102 in a different building, their preferences may be maintained. A user profile may include a data structure with a set of fields for user preferences, user characteristics, linked accounts, and user devices. For example, there may be a name field (e.g., the actual user’s name), a username field (may or may not resemble the user’s name), user age, etc.

Although not illustrated, user 106 may edit and view the fields of their profile using an app on user computing device 108, a web browser, or components in modular banking environment 102. For example, a user may enter in an URL for a website associated with modular banking control device 104. If user 106 does not have an account, they may create an account, which triggers a new user profile that may be stored in data store 218. User 106 may then be presented with a series of input UI elements to edit data in their user profile. For example, there may be a virtual user preference that indicates how they will look (e.g, height, hair color, etc.) to other users in a virtual environment. There may also be a preference for whether or not a virtual user should be presented to user 106 when in modular banking control device 104.

User 106 may also enter in credential information for their various financial institutions (e.g., linked accounts). In some instance, an authentication such as OAuth is used such that the actual credential information is not stored within modular banking control device 104. Instead, the financial institution may transmit back an access token to modular banking control device 104 after confirming the user’s credentials. Financial institution logic 216 may then facilitate the various transactions requests of the user with a financial institution using the token such as by debiting/crediting accounts, open or closing loans, etc.

For example, consider that the transaction request from user 106 is a withdrawal request. Financial institution logic 216 may transmit a request with the token over an API to the financial institution to determine if the transaction request may be honored by the financial institution (e.g., are there sufficient funds in the user’s account, etc.). Upon receiving confirmation that the transaction request is valid, modular banking control device 104 may transmit a command to bill dispensing device 130 to fulfil the withdrawal. Modular banking control device 104 may also transmit a command to the financial institution indicating the withdraw was successful such that the financial institution may update the user’s account.

The devices listed in a user profile may be added in several ways. For example, an application offered by an entity associated with modular banking control device 104 may be downloaded to a device (e.g., user computing device 108). A user may log in to the application using credentials previously established by user 106 and stored in their user profile. Upon successfully authentication, user computing device 108 may be added to the device list in the user profile. An associated device in the list may include an identifier such as a MAC address, an NFC identifier, etc., that may be used by a proximity sensor to identify the device.

Preferences for the appearance of the modular banking environment may also be stored in a user profile. For example, there may be several different banks that the user can enter that differ in visual appearance (e.g., resembling a user’s main bank branch, different architecture styles, an outdoor banking environment, etc.). The chosen appearance may be used by modular banking control device 104 to customize the virtual banking environment for the user.

Authentication component 208 may include instructions for execution on processing system 204 that authenticate user 106 to modular banking control device 104. Authentication may occur in a few ways including both passive and active authentications (or combinations thereof).

In a passive authentication scheme, presence detection 210 may first detect user 106 has entered modular banking environment 102 using the techniques described herein. For example, proximity sensor 116b may send interrogation signals to NFC devices within modular banking environment 102, which may include user computing device 108. Another passive authentication scheme may use facial recognition using camera 114b, for example. In an active authentication scheme, user 106 may enter in their credentials using keyboard input device 124, for example. User 106 may be requested to authenticate using a second method such as via biometric authentication device 126 in some examples.

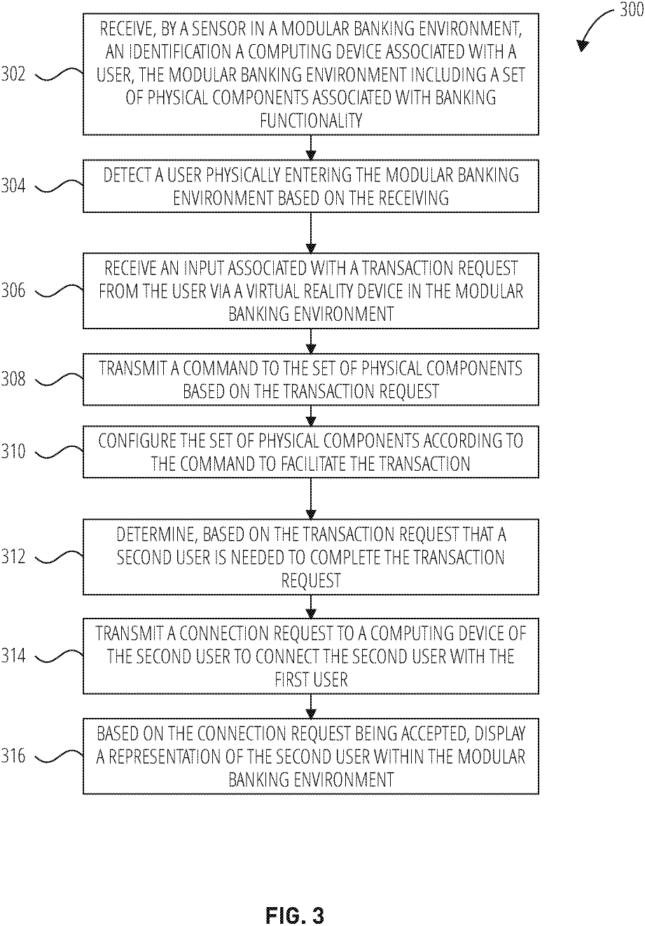

FIG. 3 is an illustration of a flowchart, according to various examples. Method 300 is represented as a series of blocks that describe operations of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 3. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At block 302, in various examples, method 300 includes receiving by a sensor in a modular banking environment, an identification a computing device associated with a user. The modular banking environment may include a set of physical components associated with banking functionality. In various examples, the sensor is a proximity sensor that detects when the user when they enter the modular banking environment. In various examples, the user may have on their person one or more computing devices (e.g., smart phones, smart watches) that include an NFC chip. In various examples, detecting may include receiving, by the sensor, an identification (e.g., by the sensor transmitting an interrogation signal) of one of the computing devices associated with the user. In various examples, associated means the computing device has been registered in a user profile as associated with the user.

The set of physical components may include electronic and non-electronic devices. In various examples, the modular banking environment includes one or more of the components in modular banking environment 102. For example, the modular banking environment may include a touchscreen for receiving a signature of the user to complete a transaction request. Similarly, a control device such as modular banking control device 104 may store a list of the set of physical components in the modular banking environment. The modular banking environment may be a room in a building that has been configured with the set of physical components. In some examples, multiple modular banking environments are deployed in the same room.

At block 304, method 300 includes detecting the user physically entering the modular banking environment based on the identification in block 302. In various examples, the method may include performing facial recognition of the user using information captured by the same or a second sensor (e.g., an optical sensor). The user may be authenticated based on the identification of the user and the facial recognition, in various examples.

At block 306, method 300 includes receiving an input associated with a transaction request from the user via a virtual reality device in the modular banking environment. A virtual reality device may take many forms, including, but not limited to a headset wearable device. In various examples, method 300 may include (but not illustrated) presenting a virtual banking environment via the headset wearable device to the user. The virtual banking environment may include an input interface (e.g., a floating menu) for selecting the transaction request.

In various examples, a virtual reality device may be a hand-held device that is communicatively coupled to a control device (e.g., modular banking control device 104). The location and orientation of the virtual reality device may be tracked by sensors in the modular banking environment or sensors of the virtual reality device itself. Accordingly, the user may make a selection by pointing at a menu option and clicking a button the hand-held device or making a gesture, in various examples. The hand-held device may include haptics as well such that a user may be able receive feedback if they virtually sign a document in the air, for example.

In various example, method 300 may also include determining, based on the transaction request that a component required for the transaction request is part of the set of physical components. For example, if the transaction request is for a withdraw, the control device may check to see if the set of physical components included a bill dispensing device. If it does not, a message may be presented to the user (e.g., via their virtual reality device or a display device such as display device 118) that indicates their transaction request cannot be completed.

In various examples, the user in block 302 is a first user and the method may further include, at block 312, determining, based on the transaction request that a second user is needed to complete the transaction request. The modular banking control device 104 may store a list of the possible transaction requests and associated components and the number of parties required to complete a transaction request. For example, the transaction request may be to open a loan with multiple co-signers. In such as instance it may first be determined if the second user is already virtually or physically (e.g., as established by the sensors in the room) present in the modular banking environment. The identity of the second user may be determined based on the first user entering the second user’s information into an input element of the modular banking environment in various examples.

When the second user is not already present, a connection request may be transmitted to a computing device of the second user to connect the second user with the first user at block 314. For example, the user profile of the second user may be accessed and a message may be transmitted to an associated device. In various examples, the second user may already be in their own modular banking environment. In such an instance, a message may be transmitted to the second user within their respective modular banking environment to connect with the first user. Based on the connection request being accepted at block 316 (e.g., the second user activates a UI element on their phone, etc.) a representation (e.g., an avatar or three-dimensional model) of the second user may be displayed within the modular banking environment of the first user and vice-a-versa.

At block 308, method 300 includes transmitting a command to the set of physical components based on the transaction request. At block 310, method 300 includes configuring the set of physical components according to the command to facilitate the transaction. For example, the set of physical components may include a bill dispensing device and the transaction request may be a withdrawal request. Accordingly, the command may include an instruction to the bill dispensing device to dispense a set of bills according to the input (e.g., withdraw X amount of dollars) associated with the transaction request.

When the transaction request is to apply for a loan, the command may include an instruction to present loan terms to the user via headset wearable device 132. For example, the terms may be appear as if they are laying on a table in the modular banking environment.

In various examples, a second user may be presented to the first user in the modular banking environment. The second user may be a financial institution agent in their own modular banking environment. In such a scenario, the first user and second user may interact as if they were together in a bank branch. Furthermore, actions taken by the second user (e.g., an agent user) in their modular banking environment may be mapped to components within the modular banking environment of the first user.

For example, consider that the transaction request may be a withdraw request. The second user may pick up money in their modular banking environment and hand it to the virtual representation of the first user. The physical money may be mapped (e.g., as stored in an associative array of modular banking control device 104) to the bill dispensing device in the first user’s modular banking environment. Accordingly, when the money is within a certain proximity of the virtual representation of the first user (e.g., as determined by the sensors in the second user’s modular banking environment), the bill dispensing device may dispense money to the first user. In other scenarios, the second user may “hand” documents to the first user and the contents of those documents may be projected into the modular banking environment of the first user (e.g., on a table or display device).

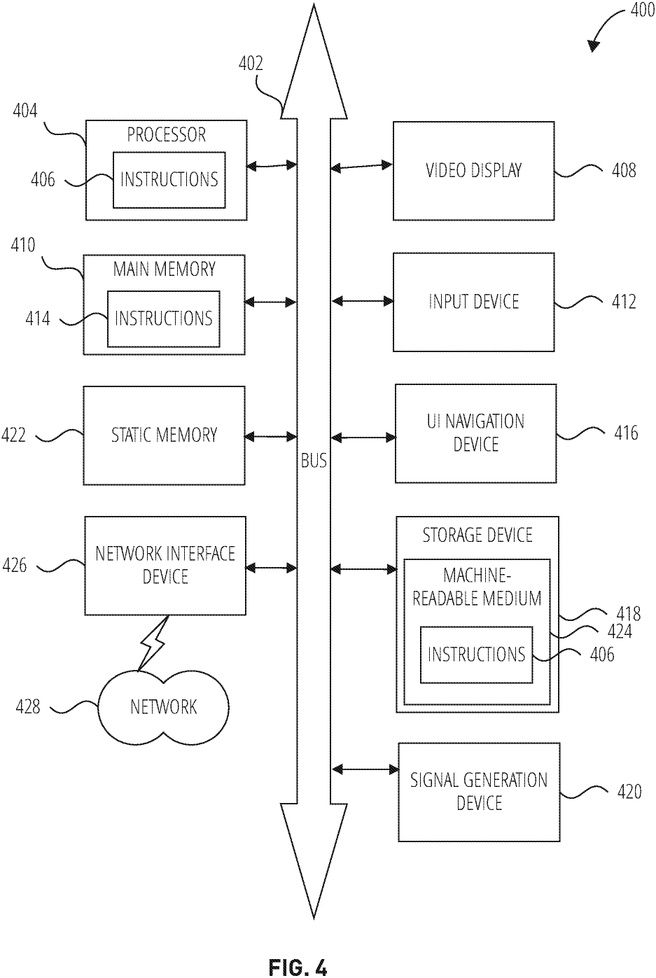

FIG. 4 is a block diagram illustrating a machine in the example form of computer system 400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 404 (e.g., a central processing unit (CPU), a graphics processing unit (GPU) or both, processor cores, compute nodes, etc.), a main memory 410 and a static memory 422, which communicate with each other via a bus 402. The computer system 400 may further include a video display 408, an input device 412 (e.g., a keyboard), and a user interface (UI) navigation device 114 (e.g., a mouse). In one embodiment, the video display 408, input device 412, and UI navigation device 416 are incorporated into a single device housing such as a touch screen display. The computer system 400 may additionally include a storage device 418 (e.g., a drive unit), a signal generation device 420 (e.g., a speaker), a network interface device 426, and one or more sensors (not shown), such as a global positioning system (GPS) sensor, compass, accelerometer, or other sensors.

The storage device 418 includes a machine-readable medium 424 on which is stored one or more sets of data structures and instructions 414 (e.g., software) embodying or utilized by any one or more of the methodologies or functions described herein. The instructions 414 may also reside, completely or at least partially, within the main memory 410, static memory 422, and/or within the processor 404 during execution thereof by the computer system 100, with the main memory 410, static memory 422, and the processor 404 also constituting machine-readable media.

While the machine-readable medium 424 is illustrated in an example embodiment to be a single medium, the term “machine-readable medium” may include a single medium or multiple media (e.g., a centralized or distributed Database, and/or associated caches and servers) that store the one or more instructions 414. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 424 that excluded transitory signals.

The instructions 414 may further be transmitted or received over a communications Network 126 using a transmission medium via the network interface device 426 utilizing any one of several well-known transfer protocols (e.g., HTTP). Examples of communication networks include a local area Network (LAN), a wide area Network (WAN), the Internet, mobile telephone networks, plain old telephone (POTS) networks, and wireless data networks (e.g., Wi-Fi, 3G, 4G LTE/LTE-A, 5G, or WiMAX networks). The term “transmission medium” shall be taken to include any intangible medium that is capable of storing, encoding, or carrying instructions for execution by the machine, and includes digital or analog communications signals or other intangible medium to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
reading, by a proximity sensor, a user identifier from a near-field-communication chip of a computing device of a first user;
based on the reading, determining that the first user has entered a first modular banking environment, the first modular banking environment including a set of physical components associated with banking functionality;
performing facial recognition of the first user using information captured by a second sensor;
configuring the first modular banking environment based on stored preferences of the first user;
within the first modular banking environment, presenting a virtual banking environment via a virtual reality headset wearable device, to the first user;
receiving an input associated with a transaction request from the first user via the virtual reality headset wearable device in the first modular banking environment;
transmitting a command to the set of physical components based on the transaction request;
facilitating the transaction by configuring the set of physical components according to the command;
determining, based on the transaction request, that a second user is needed to complete the transaction request, wherein the second user is connected to a second modular banking environment;
transmitting a message within the second modular banking environment to the second user, wherein the message is a request to connect with the first user at the first modular banking environment;
receiving an acceptance from the second user; and
in response to the acceptance:
connecting the second user with the first user;
displaying a representation of the second user within the virtual banking environment at the first modular banking environment; and
displaying a representation of the first user within the virtual banking environment at the second modular banking environment.

2. (canceled)

3. The method of claim 1,
wherein the virtual banking environment includes an input interface that receives a selection of the transaction request.

4. The method of claim 1, further comprising:
determining, based on the transaction request, that a component required for the transaction request is part of the set of physical components.

5. The method of claim 1, wherein,
the set of physical components includes a bill dispensing device; and
the transaction request is a withdrawal request; and
wherein the command includes an instruction to the bill dispensing device to dispense a set of bills according to the input associated with the transaction request.

6. The method of claim 1, wherein the set of physical components include a touchscreen and wherein the method further includes:
receiving a signature of the first user via the touchscreen; and
in response to the receiving, completing the transaction request.

7-10. (canceled)

11. A non-transitory computer-readable storage medium, the computer-readable storage medium including instructions that when executed by a computer, cause the computer to:
read, by a proximity sensor, a user identifier from a near-field-communication chip of a computing device of a first user;
based on the reading, determine that the first user has entered a first modular banking environment, the first modular banking environment including a set of physical components associated with banking functionality;
perform facial recognition of the first user using information captured by a second sensor;
configure the first modular banking environment based on stored preferences of the first user;
authenticate the first user based on the user identifier and the facial recognition;
within the first modular banking environment, present a virtual banking environment, via a virtual reality headset wearable device, to the first user;
receive an input associated with a transaction request from the first user via the virtual reality headset wearable device in the first modular banking environment;
transmit a command to the set of physical components based on the transaction request;
facilitate the transaction by configuring the set of physical components according to the command;
determine, based on the transaction request, that a second user is needed to complete the transaction request, wherein the second user is connected to a second modular banking environment;
transmit a message within the second modular banking environment to the second user, wherein the message is a request to connect with the first user at the first modular banking environment;
receive an acceptance from the second user; and
in response to the acceptance:
connect the second user with the first user;
display a representation of the second user within the virtual banking environment at the first modular banking environment; and
display a representation of the first user within the virtual banking environment at the second modular banking environment.

12. (canceled)

13. The computer-readable storage medium of claim 11, wherein
the virtual banking environment includes an input interface that receives a selection of the transaction request.

14. The computer-readable storage medium of claim 11, wherein the instructions further configure the computer to:
determine, based on the transaction request, that a component required for the transaction request is part of the set of physical components.

15. The computer-readable storage medium of claim 11, wherein, the set of physical components includes a bill dispensing device; and
the transaction request is a withdrawal request; and
wherein the command includes an instruction to the bill dispensing device to dispense a set of bills according to the input associated with the transaction request.

16. A system comprising:
at least one processor; and
a storage device comprising instructions, which when executed by the at least one processor, configure the at least one processor to:
read, by a proximity sensor, a user identifier from a near-field-communication chip of a computing device of a first user;
based on the reading, determine that the first user has entered a first modular banking environment, the first modular banking environment including a set of physical components associated with banking functionality;
perform facial recognition of the first user using information captured by a second sensor;
configure the first modular banking environment based on stored preferences of the first user;
authenticate the first user based on the user identifier and the facial recognition;
within the first modular banking environment, present a virtual banking environment, via a virtual reality headset wearable device, to the first user;
receive an input associated with a transaction request from the first user via the virtual reality headset wearable device in the first modular banking environment;
transmit a command to the set of physical components based on the transaction request;
facilitate the transaction by configuring the set of physical components according to the command;
determine, based on the transaction request, that a second user is needed to complete the transaction request, wherein the second user is connected to a second modular banking environment;
transmit a message within the second modular banking environment to the second user wherein the message is a request to connect with the first user at the first modular banking environment;
receive an acceptance from the second user; and
in response to the acceptance:
connect the second user with the first user;
display a representation of the second user within the virtual banking environment at the first modular banking environment; and
display a representation of the first user within the virtual banking environment at the second modular banking environment.

17. (canceled)

18. The system of claim 16, wherein
the virtual banking environment includes an input interface that receives a selection of the transaction request.

19. The system of claim 16, wherein the instructions, when executed by the at least one processor, further configure the at least one processor to:
determine, based on the transaction request that a component required for the transaction request is part of the set of physical components.

20. The system of claim 16, wherein, the set of physical components includes a bill dispensing device; and
the transaction request is a withdrawal request; and
wherein the command includes an instruction to the bill dispensing device to dispense a set of bills according to the input associated with the transaction request.
